(19) United States
(12) Patent Application Publication
(10) Pub. No.: US 2015/0180186 A1
(43) Pub. Date: Jun. 25, 2015

(54) Systems and Apparatus for Cable Management

(71) Applicant: Google Inc., Mountain View, CA (US)

(72) Inventors: Damon Vander Lind, Alameda, CA (US); Brian Hachtmann, San Martin, CA (US)

(73) Assignee: Google Inc., Mountain View, CA (US)

(21) Appl. No.: 14/137,724

(22) Filed: Dec. 20, 2013

(51) Int. Cl. H01R 35/02; F03D 9/00; H01R 39/64

(52) U.S. Cl. CPC H01R 35/02; H01R 39/64; F03D 9/003

(57) ABSTRACT

Wind energy systems, such as an Airborne Wind Turbine (“AWT”), may be used to facilitate conversion of kinetic energy to electrical energy. An AWT may include an aerial vehicle that flies in a path to convert kinetic wind energy to electrical energy. The aerial vehicle may be tethered to a ground station via a tether. As a result of continuous circular flights paths, the tether may rotate continuously in one direction. Thus, it may be desirable to have a cable management apparatus that allows for tether rotation and helps reduce strain on the tether.

### BACKGROUND

Unless otherwise indicated herein, the materials described in this section are not prior art to the claims in this application and are not admitted to be prior art by inclusion in this section.

Power generation systems may convert chemical and/or mechanical energy (e.g., kinetic energy) to electrical energy for various applications, such as utility systems. As one example, a wind energy system may convert kinetic wind energy to electrical energy.

### SUMMARY

The present disclosure generally relates to systems and methods that incorporate a ground station for tethering aerial vehicles such as those employed in crosswind aerial vehicle systems. Crosswind aerial vehicle systems may extract useful power from the wind for various purposes such as, for example, generating electricity, lifting or towing objects or vehicles, etc. Deploying and receiving the aerial vehicles to generate power may present difficulties due to, for example, changing wind conditions and/or turbulent wind conditions. Beneficially, embodiments described herein may allow for more reliable, safe, and efficient deployment and reception of aerial vehicles. These as well as other aspects, advantages, and alternatives will become apparent to those of ordinary skill in the art by reading the following detailed description, with reference where appropriate to the accompanying drawings.

In one aspect, a cable management apparatus is provided. The cable management apparatus may include a drum that is rotatable about an axis of the drum. The drum may have an exterior surface and an interior cavity. The cable management apparatus may include a tether gimbal assembly attached to the drum, and the tether gimbal assembly may be rotatable about one axis, such as an altitude axis. The cable management apparatus may include a flexible coupling that may have a first end coupled to the tether gimbal assembly and a second end. The cable management apparatus may include a slip ring that may have a stationary slip ring portion, a rotatable slip ring portion, and one or more insulated electrical conductors. The stationary slip ring portion may be configured to remain substantially stationary relative to rotation of the drum about the axis of the drum and may include one or more insulated electrically conductive pathways. The rotatable slip ring portion may be configured to rotate relative to the stationary slip ring portion. The rotatable slip ring portion may include one or more insulated electrical conductors. The rotatable slip ring portion may be coupled to the second end of the flexible coupling. The one or more insulated electrically conductive pathways may couple the one or more insulated electrical conductors of the stationary slip ring portion to corresponding insulated electrical conductors of the rotatable slip ring portion. The cable management apparatus may include a tether. The tether may include one or more insulated electrical conductors. The tether may include a distal tether end extending outside of the drum that is configured to electrically couple the one or more insulated electrical conductors of the tether to an aerial vehicle. The tether may further include a main tether body extending through the tether gimbal assembly and through the flexible coupling. The tether may further include a proximate tether end where the one or more insulated electrical conductors of the tether may be coupled to corresponding insulated electrical conductors of the rotatable slip ring portion.

In another aspect, a cable management apparatus is provided. The cable management apparatus may include a drum that is rotatable about an axis of the drum. The drum may have an exterior surface and an interior cavity. The cable management apparatus may include a base platform coupled to the drum and rotatably coupled to a support tower. The cable management apparatus may include a tether gimbal assembly attached to the drum, and the tether gimbal assembly may be rotatable about one axis, such as an altitude axis. The cable management apparatus may include a flexible coupling that may have a first end coupled to the tether gimbal assembly and a second end. The cable management apparatus may include a slip ring that may have a stationary slip ring portion, a rotatable slip ring portion, and one or more insulated electrical conductors. The stationary slip ring portion may be configured to remain substantially stationary relative to rotation of the support tower about the axis of the support tower and may include one or more insulated electrically conductive pathways. The rotatable slip ring portion may be configured to rotate relative to the stationary slip ring portion. The rotatable slip ring portion may include one or more insulated electrical conductors. The rotatable slip ring portion may be coupled to the second end of the flexible coupling. The one or more insulated electrically conductive pathways may couple the one or more insulated electrical conductors of the stationary slip ring portion to corresponding insulated electrical conductors of the rotatable slip ring portion. The cable management apparatus may include a tether. The tether may include one or more insulated electrical conductors. The tether may include a distal tether end extending outside of the drum that is configured to electrically couple the one or more insulated electrical conductors of the tether to an aerial vehicle. The tether may further include a main tether body extending through the tether gimbal assembly and through the flexible coupling. The tether may further include a proximate tether end where the one or more insulated electrical conductors of the tether may be coupled to corresponding insulated electrical conductors of the rotatable slip ring portion.

In another aspect, a cable management apparatus is provided. The cable management apparatus may include a drum that is rotatable about an axis of the drum. The drum may have an exterior surface and an interior cavity. The cable management apparatus may include a base platform coupled to the drum and rotatably coupled to a support tower. The cable management apparatus may include a tether gimbal assembly attached to the drum, and the tether gimbal assembly may be rotatable about at least two axes such as an altitude axis, and an azimuth axis. The cable management apparatus may include a flexible coupling that may have a first end coupled to the tether gimbal assembly and a second end. The cable management apparatus may include a slip ring that may have a stationary slip ring portion, a rotatable slip ring portion, and two or more insulated electrical conductors. The stationary slip ring portion may be configured to remain substantially stationary relative to rotation of the drum about the axis of the drum and may include two or more insulated electrically conductive pathways. The rotatable slip ring portion may be configured to rotate relative to the stationary slip ring portion. The rotatable slip ring portion may include two or more insulated electrical conductors. The rotatable slip ring portion may be coupled to the second end of the flexible coupling. The two or more insulated electrically conductive pathways may couple the two or more insulated electrical conductors of the stationary slip ring portion to corresponding insulated electrical conductors of the rotatable slip ring portion. The cable management apparatus may include a tether. The tether may include two or more insulated electrical conductors. The tether may include a distal tether end extending outside of the drum that is configured to electrically couple the two or more insulated electrical conductors of the tether to an aerial vehicle. The tether may further include a main tether body extending through the tether gimbal assembly and through the flexible coupling. The tether may further include a proximate tether end where the two or more insulated electrical conductors of the tether may be coupled to corresponding insulated electrical conductors of the rotatable slip ring portion.

### BRIEF DESCRIPTION OF THE DRAWINGS

FIG. 1 illustrates an Airborne Wind Turbine (AWT), according to an example embodiment.

FIG. 2 illustrates a simplified block diagram illustrating components of an AWT, according to an example embodiment.

FIG. 3 is a cross-sectional view of a cable management apparatus, according to an example embodiment.

FIG. 4 illustrates portions of a cable management apparatus including a torsion spring flexible coupling, according to an example embodiment.

FIG. 5 illustrates portions of a cable management apparatus including a universal joint flexible coupling, according to an example embodiment.

FIG. 6 is a cross-sectional view of a cable management apparatus, according to an example embodiment.

### DETAILED DESCRIPTION

Example methods and systems are described herein. It should be understood that the words “example,” “exemplary,” and “illustrative” are used herein to mean “serving as an example, instance, or illustration.” Any embodiment or feature described herein as being an “example,” being “exemplary,” or being “illustrative” is not necessarily to be construed as preferred or advantageous over other embodiments or features. The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

### I. Overview

Example embodiments relate to aerial vehicles, which may be used in a wind energy system, such as an Airborne Wind Turbine (AWT). In particular, example embodiments may relate to or take the form of methods and systems for facilitating an aerial vehicle in the process of conversion of kinetic energy to electrical energy.

By way of background, an AWT may include an aerial vehicle that flies in a path, such as a substantially circular path, to convert kinetic wind energy to electrical energy via onboard turbines. In an example embodiment, the aerial vehicle may be connected to a ground station via a tether. While tethered, the aerial vehicle may: (i) fly at a range of elevations and substantially along the path, and return to the ground, and (ii) transmit electrical energy to the ground station via the tether. In some embodiments, the ground station may transmit electricity to the aerial vehicle for take-off and/or landing.

In an AWT, an aerial vehicle may rest in and/or on a ground station when the wind is not conducive to power generation. When the wind is conducive to power generation, such as when a wind speed may be 10 meters per second (m/s) at an altitude of 200 meters (m), the ground station may deploy (or launch) the aerial vehicle. In addition, when the aerial vehicle is deployed and the wind is not conducive to power generation, the aerial vehicle may return to the ground station.

Moreover, in an AWT, an aerial vehicle may be configured for hover flight and crosswind flight. Crosswind flight may be used to travel in a motion, such as a substantially circular motion, and thus may be the primary technique that is used to generate electrical energy. Hover flight in turn may be used by the aerial vehicle to prepare and position itself for crosswind flight. In particular, the aerial vehicle could ascend to a location for crosswind flight based at least in part on hover flight. Further, the aerial vehicle could take-off and/or land via hover flight.

In hover flight, a span of a main wing of the aerial vehicle may be oriented substantially parallel to the ground, and one or more propellers of the aerial vehicle may cause the aerial vehicle to hover over the ground. In some embodiments, the aerial vehicle may vertically ascend or descend in hover flight.

In crosswind flight, the aerial vehicle may be propelled by the wind substantially along a path, which as noted above, may convert kinetic wind energy to electrical energy. In some embodiments, the one or more propellers of the aerial vehicle may generate electrical energy by slowing down the incident wind.

The aerial vehicle may enter crosswind flight when (i) the aerial vehicle has attached wind-flow (e.g., steady flow and/or no stall condition (which may refer to no separation of air flow from an airfoil)) and (ii) the tether is under tension. Moreover, the aerial vehicle may enter crosswind flight at a location that is substantially downwind of the ground station.

Some previous tethered systems have used a varying length tether. An example embodiment, in contrast, facilitates the use of a fixed length tether. For example, a fixed length tether may be approximately 500 meters long and approximately 20 millimeters in diameter. The tether may include one or more insulated conductors to transmit electrical energy, or other electrical signals, along the tether length.

A tether termination mount at the ground station may be desirable for various reasons. For example, the aerial vehicle in cross-wind flight may oscillate many times over the life of the system (foe e.g., 30 million cycles of aerial vehicle and tether rotation) so a tether termination mount may be desirable that does not wear, or rub, the tether. In the case of rigid or semi-rigid tethers, a tether termination mount may be desirable that does not impart significant bending loads onto the tether.

In the case of a tether with one or more conductors, a tether termination mount may be desirable that does not accumulate twists in the tether. Tether twisting may be a problem because a twisted tether may have reduced conductivity due to the twisting or eventual breaking of the conductor(s). For example, the tether termination mount may either actively or passively rotate to align the tether at the ground-side system with the motion of the aerial vehicle. The tether termination mount may include a servomotor or other drive mechanism to manually rotate the tether and reduce the likelihood of significant tether twisting. Additionally in the case of a tether with one or more conductors, a tether termination mount may be desirable that communicates power either into the ground side system or out to the aerial vehicle.

### II. Illustrative Systems

A. Airborne Wind Turbine (AWT)

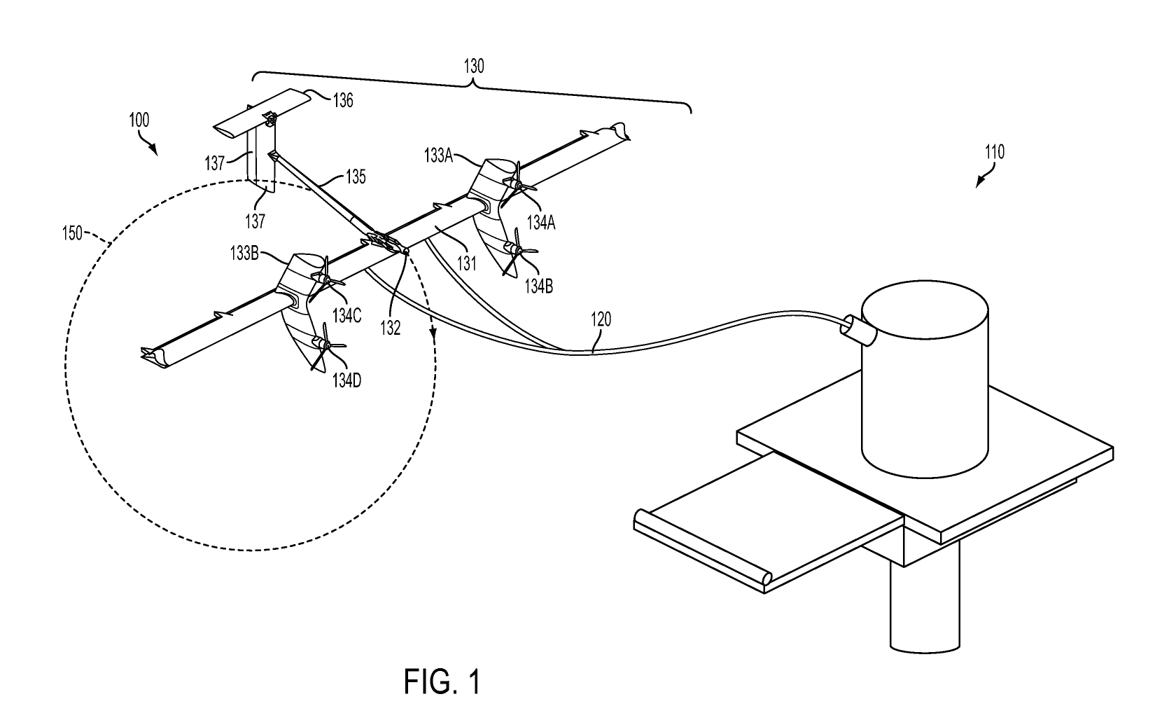

FIG. 1 depicts an AWT 100, according to an example embodiment. In particular, the AWT 100 includes a ground station 110, a tether 120, and an aerial vehicle 130. As shown in FIG. 1, the aerial vehicle 130 may be connected to the tether 120, and the tether 120 may be connected to the ground station 110. In this example, the tether 120 may be attached to the ground station 110 at one location on the ground station 110, and attached to the aerial vehicle 130 at two locations on the aerial vehicle 130. However, in other examples, the tether 120 may be attached at multiple locations to any part of the ground station 110 and/or the aerial vehicle 130.

The ground station 110 may be used to hold and/or support the aerial vehicle 130 until it is in an operational mode. The ground station 110 may also be configured to allow for the repositioning of the aerial vehicle 130 such that deploying of the device is possible. Further, the ground station 110 may be further configured to receive the aerial vehicle 130 during a landing. The ground station 110 may be formed of any material that can suitably keep the aerial vehicle 130 attached and/or anchored to the ground while transitioning between hover and crosswind flight.

In addition, the ground station 110 may include one or more components (not shown), such as a winch, that may vary a length of the tether 120. Such components will be described in greater detail later in this disclosure. For example, when the aerial vehicle 130 is deployed, the one or more components may be configured to pay out and/or reel out the tether 120. In some implementations, the one or more components may be configured to pay out and/or reel out the tether 120 to a predetermined length. As examples, the predetermined length could be equal to or less than a maximum length of the tether 120. Further, when the aerial vehicle 130 lands in the ground station 110, the one or more components may be configured to reel in the tether 120.

The tether 120 may transmit electrical energy generated by the aerial vehicle 130 to the ground station 110. In addition, the tether 120 may transmit electricity to the aerial vehicle 130 in order to power the aerial vehicle 130 for takeoff, landing, hover flight, and/or forward flight. The tether 120 may be constructed in any form and using any material which may allow for the transmission, delivery, and/or harnessing of electrical energy generated by the aerial vehicle 130 and/or transmission of electricity to the aerial vehicle 130. The tether 120 may also be configured to withstand one or more forces of the aerial vehicle 130 when the aerial vehicle 130 is in an operational mode. For example, the tether 120 may include a core configured to withstand one or more forces of the aerial vehicle 130 when the aerial vehicle 130 is in hover flight, forward flight, and/or crosswind flight. The core may be constructed of any high strength fibers. In some examples, the tether 120 may have a fixed length and/or a variable length. For instance, in at least one such example, the tether 120 may have a length of 140 meters. However other lengths may be used as well.

The aerial vehicle 130 may be configured to fly substantially along a path 150 to generate electrical energy. The term “substantially along,” as used in this disclosure, refers to exactly along and/or one or more deviations from exactly along that do not significantly impact generation of electrical energy as described herein and/or transitioning an aerial vehicle between certain flight modes as described herein.

The aerial vehicle 130 may include or take the form of various types of devices, such as a kite, a helicopter, a wing and/or an airplane, among other possibilities. The aerial vehicle 130 may be formed of solid structures of metal, plastic and/or other polymers. The aerial vehicle 130 may be formed of any material which allows for a high thrust-to-weight ratio and generation of electrical energy which may be used in utility applications. Additionally, the materials may be chosen to allow for a lightning hardened, redundant and/or fault tolerant design which may be capable of handling large and/or sudden shifts in wind speed and wind direction. Other materials may be used in the formation of aerial vehicle as well.

The path 150 may be various different shapes in various different embodiments. For example, the path 150 may be substantially circular. And in at least one such example, the path 150 may have a radius of up to 265 meters. The term “substantially circular,” as used in this disclosure, refers to exactly circular and/or one or more deviations from exactly circular that do not significantly impact generation of electrical energy as described herein. Other shapes for the path 150 may be an oval, such as an ellipse, the shape of a jelly bean, the shape of the number of 8, etc.

As shown in FIG. 1, the aerial vehicle 130 may include a main wing 131, a front section 132, rotor connectors 133A-B, rotors 134A-D, a tail boom 135, a tail wing 136, and a vertical stabilizer 137. Any of these components may be shaped in any form which allows for the use of components of lift to resist gravity and/or move the aerial vehicle 130 forward.

The main wing 131 may provide a primary lift for the aerial vehicle 130. The main wing 131 may be one or more rigid or flexible airfoils, and may include various control surfaces, such as winglets, flaps, rudders, elevators, etc. The control surfaces may be used to stabilize the aerial vehicle 130 and/or reduce drag on the aerial vehicle 130 during hover flight, forward flight, and/or crosswind flight.

The main wing 131 may be any suitable material for the aerial vehicle 130 to engage in hover flight, forward flight, and/or crosswind flight. For example, the main wing 131 may include carbon fiber and/or e-glass. Moreover, the main wing 131 may have a variety dimensions. For example, the main wing 131 may have one or more dimensions that correspond with a conventional wind turbine blade. As another example, the main wing 131 may have a span of 8 meters, an area of 4 meters squared, and an aspect ratio of 15. The front section 132 may include one or more components, such as a nose, to reduce drag on the aerial vehicle 130 during flight.

The rotor connectors 133A-B may connect the rotors 134A-D to the main wing 131. In some examples, the rotor connectors 133A-B may take the form of or be similar in form to one or more pylons. In this example, the rotor connectors 133A-B are arranged such that the rotors 134A-D are spaced between the main wing 131. In some examples, a vertical spacing between corresponding rotors (e.g., rotor 134A and rotor 134B or rotor 134C and rotor 134D) may be 0.9 meters.

The rotors 134A-D may be configured to drive one or more generators for the purpose of generating electrical energy. In this example, the rotors 134A-D may each include one or more blades, such as three blades. The one or more rotor blades may rotate via interactions with the wind and which could be used to drive the one or more generators. In addition, the rotors 134A-D may also be configured to provide a thrust to the aerial vehicle 130 during flight. With this arrangement, the rotors 134A-D may function as one or more propulsion units, such as a propeller. Although the rotors 134A-D are depicted as four rotors in this example, in other examples the aerial vehicle 130 may include any number of rotors, such as less than four rotors or more than four rotors that may be spaced along main wing 131.

The tail boom 135 may connect the main wing 131 to the tail wing 136. The tail boom 135 may have a variety of dimensions. For example, the tail boom 135 may have a length of 2 meters. Moreover, in some implementations, the tail boom 135 could take the form of a body and/or fuselage of the aerial vehicle 130. And in such implementations, the tail boom 135 may carry a payload.

The tail wing 136 and/or the vertical stabilizer 137 may be used to stabilize the aerial vehicle and/or reduce drag on the aerial vehicle 130 during hover flight, forward flight, and/or crosswind flight. For example, the tail wing 136 and/or the vertical stabilizer 137 may be used to maintain a pitch of the aerial vehicle 130 during hover flight, forward flight, and/or crosswind flight. In this example, the vertical stabilizer 137 is attached to the tail boom 135, and the tail wing 136 is located on top of the vertical stabilizer 137. The tail wing 136 may have a variety of dimensions. For example, the tail wing 136 may have a length of 2 meters. Moreover, in some examples, the tail wing 136 may have a surface area of 0.45 meters squared. Further, in some examples, the tail wing 136 may be located 1 meter above a center of mass of the aerial vehicle 130.

While the aerial vehicle 130 has been described above, it should be understood that the methods and systems described herein could involve any suitable aerial vehicle that is connected to a tether, such as the tether 120.

B. Illustrative Components of an AWT

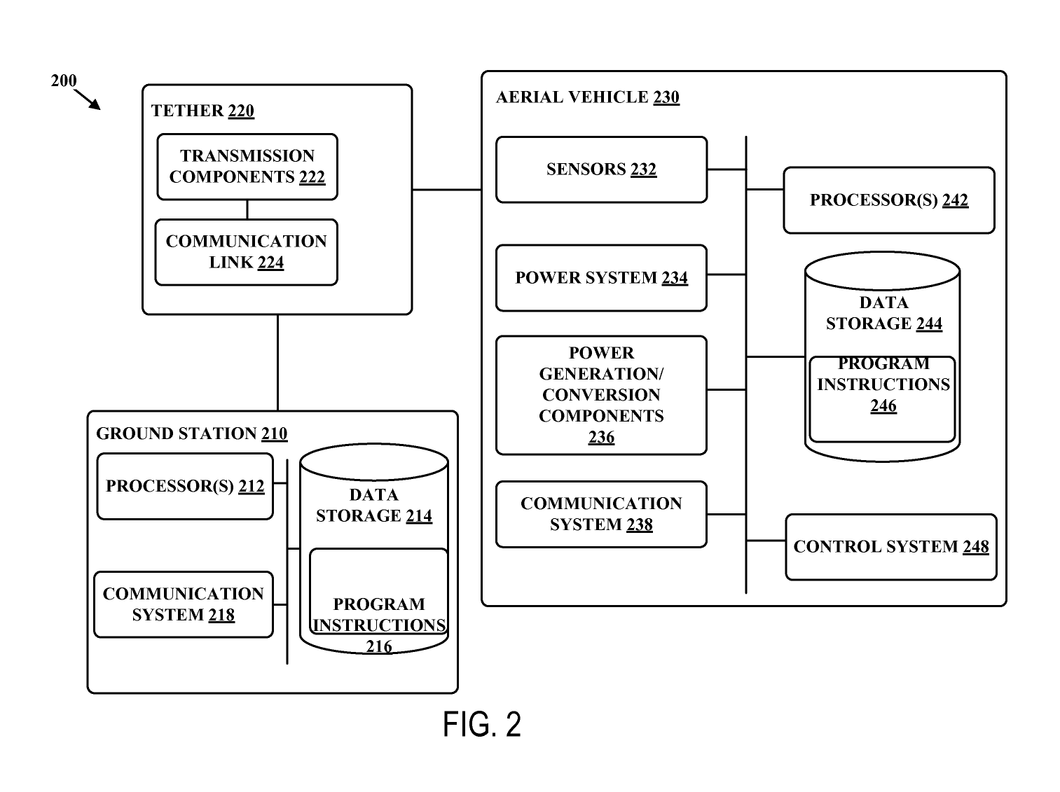

FIG. 2 is a simplified block diagram illustrating components of the AWT 200. The AWT 200 may take the form of or be similar in form to the AWT 100. In particular, the AWT 200 includes a ground station 210, a tether 220, and an aerial vehicle 230. The ground station 210 may take the form of or be similar in form to the ground station 110, the tether 220 may take the form of or be similar in form to the tether 120, and the aerial vehicle 230 may take the form of or be similar in form to the aerial vehicle 130.

As shown in FIG. 2, the ground station 210 may include one or more processors 212, data storage 214, and program instructions 216. A processor 212 may be a general-purpose processor or a special purpose processor (e.g., digital signal processors, application specific integrated circuits, etc.). The one or more processors 212 can be configured to execute computer-readable program instructions 216 that are stored in data storage 214 and are executable to provide at least part of the functionality described herein.

The data storage 214 may include or take the form of one or more computer-readable storage media that may be read or accessed by at least one processor 212. The one or more computer-readable storage media may include volatile and/or non-volatile storage components, such as optical, magnetic, organic or other memory or disc storage, which may be integrated in whole or in part with at least one of the one or more processors 212. In some embodiments, the data storage 214 may be implemented using a single physical device (e.g., one optical, magnetic, organic or other memory or disc storage unit), while in other embodiments, the data storage 214 can be implemented using two or more physical devices.

As noted, the data storage 214 may include computer-readable program instructions 216 and perhaps additional data, such as diagnostic data of the ground station 210. As such, the data storage 214 may include program instructions to perform or facilitate some or all of the functionality described herein.

In a further respect, the ground station 210 may include a communication system 218. The communications system 218 may include one or more wireless interfaces and/or one or more wireline interfaces, which allow the ground station 210 to communicate via one or more networks. Such wireless interfaces may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network. The ground station 210 may communicate with the aerial vehicle 230, other ground stations, and/or other entities (e.g., a command center) via the communication system 218.

In an example embodiment, the ground station 210 may include communication systems 218 that may allow for both short-range communication and long-range communication. For example, ground station 210 may be configured for short-range communications using Bluetooth and may be configured for long-range communications under a CDMA protocol. In such an embodiment, the ground station 210 may be configured to function as a “hot spot”; or in other words, as a gateway or proxy between a remote support device (e.g., the tether 220, the aerial vehicle 230, and other ground stations) and one or more data networks, such as cellular network and/or the Internet. Configured as such, the ground station 210 may facilitate data communications that the remote support device would otherwise be unable to perform by itself.

For example, the ground station 210 may provide a WiFi connection to the remote device, and serve as a proxy or gateway to a cellular service provider's data network, which the ground station 210 might connect to under an LTE or a 3G protocol, for instance. The ground station 210 could also serve as a proxy or gateway to other ground stations or a command station, which the remote device might not be able to otherwise access.

Moreover, as shown in FIG. 2, the tether 220 may include transmission components 222 and a communication link 224. The transmission components 222 may be configured to transmit electrical energy from the aerial vehicle 230 to the ground station 210 and/or transmit electrical energy from the ground station 210 to the aerial vehicle 230. The transmission components 222 may take various different forms in various different embodiments. For example, the transmission components 222 may include one or more insulated conductors that are configured to transmit electricity. And in at least one such example, the one or more conductors may include aluminum and/or any other material which may allow for the conduction of electric current. Moreover, in some implementations, the transmission components 222 may surround a core of the tether 220 (not shown).

The ground station 210 may communicate with the aerial vehicle 230 via the communication link 224. The communication link 224 may be bidirectional and may include one or more wired and/or wireless interfaces. Also, there could be one or more routers, switches, and/or other devices or networks making up at least a part of the communication link 224.

Further, as shown in FIG. 2, the aerial vehicle 230 may include one or more sensors 232, a power system 234, power generation/conversion components 236, a communication system 238, one or more processors 242, data storage 244, and program instructions 246, and a control system 248.

The sensors 232 could include various different sensors in various different embodiments. For example, the sensors 232 may include a global a global positioning system (GPS) receiver. The GPS receiver may be configured to provide data that is typical of well-known GPS systems (which may be referred to as a global navigation satellite system (GNNS)), such as the GPS coordinates of the aerial vehicle 230. Such GPS data may be utilized by the AWT 200 to provide various functions described herein.

As another example, the sensors 232 may include one or more wind sensors, such as one or more pitot tubes. The one or more wind sensors may be configured to detect apparent and/or relative wind. Such wind data may be utilized by the AWT 200 to provide various functions described herein.

Still as another example, the sensors 232 may include an inertial measurement unit (IMU). The IMU may include both an accelerometer and a gyroscope, which may be used together to determine the orientation of the aerial vehicle 230. In particular, the accelerometer can measure the orientation of the aerial vehicle 230 with respect to earth, while the gyroscope measures the rate of rotation around an axis, such as a centerline of the aerial vehicle 230. IMUs are commercially available in low-cost, low-power packages. For instance, the IMU may take the form of or include a miniaturized MicroElectroMechanical System (MEMS) or a NanoElectroMechanical System (NEMS). Other types of IMUs may also be utilized. The IMU may include other sensors, in addition to accelerometers and gyroscopes, which may help to better determine position. Two examples of such sensors are magnetometers and pressure sensors. Other examples are also possible.

While an accelerometer and gyroscope may be effective at determining the orientation of the aerial vehicle 230, slight errors in measurement may compound over time and result in a more significant error. However, an example aerial vehicle 230 may be able mitigate or reduce such errors by using a magnetometer to measure direction. For example, vehicle 230 may employ drift mitigation through fault tolerant redundant position and velocity estimations. One example of a magnetometer is a low-power, digital 3-axis magnetometer, which may be used to realize an orientation independent electronic compass for accurate heading information. However, other types of magnetometers may be utilized as well.

The aerial vehicle 230 may also include a pressure sensor or barometer, which can be used to determine the altitude of the aerial vehicle 230. Alternatively, other sensors, such as sonic altimeters or radar altimeters, can be used to provide an indication of altitude, which may help to improve the accuracy of and/or prevent drift of the IMU.

As noted, the aerial vehicle 230 may include the power system 234. The power system 234 could take various different forms in various different embodiments. For example, the power system 234 may include one or more batteries for providing power to the aerial vehicle 230. In some implementations, the one or more batteries may be rechargeable and each battery may be recharged via a wired connection between the battery and a power supply and/or via a wireless charging system, such as an inductive charging system that applies an external time-varying magnetic field to an internal battery and/or charging system that uses energy collected from one or more solar panels.

As another example, the power system 234 may include one or more motors or engines for providing power to the aerial vehicle 230. In some implementations, the one or more motors or engines may be powered by a fuel, such as a hydrocarbon-based fuel. And in such implementations, the fuel could be stored on the aerial vehicle 230 and delivered to the one or more motors or engines via one or more fluid conduits, such as piping. In some implementations, the power system 234 may be implemented in whole or in part on the ground station 210.

As noted, the aerial vehicle 230 may include the power generation/conversion components 236. The power generation/conversion components 326 could take various different forms in various different embodiments. For example, the power generation/conversion components 236 may include one or more generators, such as high-speed, direct-drive generators. With this arrangement, the one or more generators may be driven by one or more rotors, such as the rotors 134A-D. And in at least one such example, the one or more generators may operate at full rated power in wind speeds of 11.5 meters per second at a capacity factor which may exceed 60 percent, and the one or more generators may generate electrical power from 40 kilowatts to 600 megawatts.

Moreover, as noted, the aerial vehicle 230 may include a communication system 238. The communication system 238 may take the form of or be similar in form to the communication system 218. The aerial vehicle 230 may communicate with the ground station 210, other aerial vehicles, and/or other entities (e.g., a command center) via the communication system 238.

In some implementations, the aerial vehicle 230 may be configured to function as a “hot spot”; or in other words, as a gateway or proxy between a remote support device (e.g., the ground station 210, the tether 220, other aerial vehicles) and one or more data networks, such as cellular network and/or the Internet. Configured as such, the aerial vehicle 230 may facilitate data communications that the remote support device would otherwise be unable to perform by itself.

For example, the aerial vehicle 230 may provide a WiFi connection to the remote device, and serve as a proxy or gateway to a cellular service provider's data network, which the aerial vehicle 230 might connect to under an LTE or a 3G protocol, for instance. The aerial vehicle 230 could also serve as a proxy or gateway to other aerial vehicles or a command station, which the remote device might not be able to otherwise access.

As noted, the aerial vehicle 230 may include the one or more processors 242, the program instructions 244, and the data storage 246. The one or more processors 242 can be configured to execute computer-readable program instructions 246 that are stored in the data storage 244 and are executable to provide at least part of the functionality described herein. The one or more processors 242 may take the form of or be similar in form to the one or more processors 212, the data storage 244 may take the form of or be similar in form to the data storage 214, and the program instructions 246 may take the form of or be similar in form to the program instructions 216.

Moreover, as noted, the aerial vehicle 230 may include the control system 248. In some implementations, the control system 248 may be configured to perform one or more functions described herein. The control system 248 may be implemented with mechanical systems and/or with hardware, firmware, and/or software. As one example, the control system 248 may take the form of program instructions stored on a non-transitory computer readable medium and a processor that executes the instructions. The control system 248 may be implemented in whole or in part on the aerial vehicle 230 and/or at least one entity remotely located from the aerial vehicle 230, such as the ground station 210. Generally, the manner in which the control system 248 is implemented may vary, depending upon the particular application.

While the aerial vehicle 230 has been described above, it should be understood that the methods and systems described herein could involve any suitable vehicle that is connected to a tether, such as the tether 230 and/or the tether 110.

C. Illustrative Components of a Cable Management Apparatus

All figures in this description are representational only and not all components are shown. For example, additional structural or restraining components may not be shown.

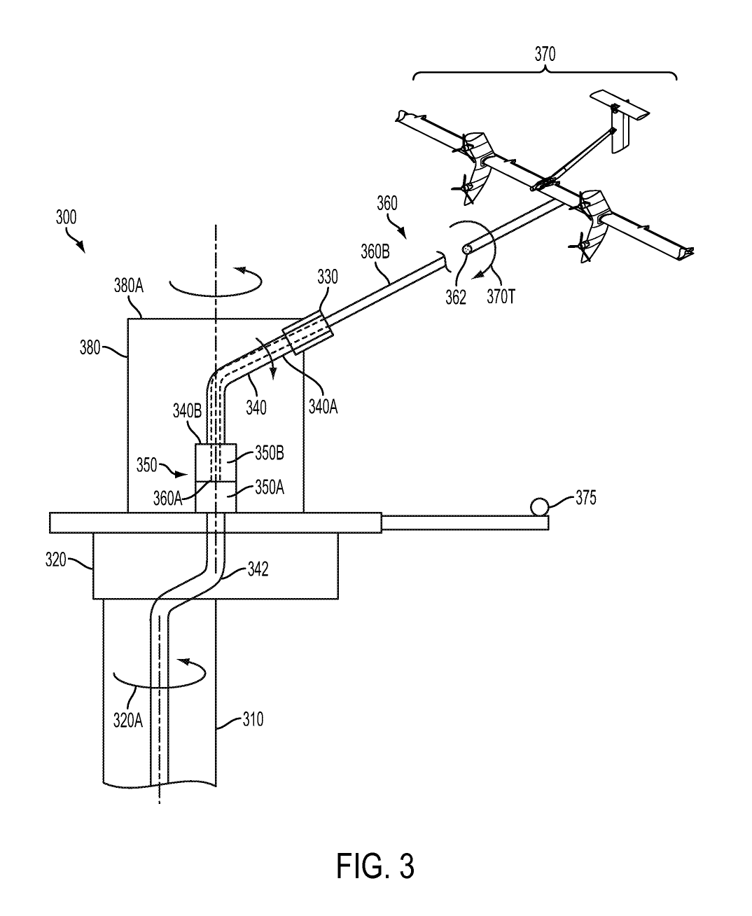

FIG. 3 is a cross-sectional view of a cable management apparatus, according to an example embodiment. Cable management apparatus 300 may include a support tower 310, a base platform, 320, a tether gimbal assembly 330, a flexible coupling 340, a second flexible coupling 342, a slip ring 350, a tether 360, an aerial vehicle 370, and a drum 380.

Base platform 320 may be coupled to the drum 380 and rotatably coupled to support tower 310. Base platform 320, drum 380, and support tower 310 may all be configured to rotate about one or more axes. For example, base platform 320, drum 380, and support tower 310 may be configured to rotate independently of each other about one or more axes of rotation, such as an azimuth axis, an altitude axis, or other axes of rotation. In a further aspect, one or more components of cable management apparatus 300, such as base platform 320 and support tower 310, may be configured to rotate substantially together about a first axis, such as an azimuth axis, and one or more components of cable management apparatus, such as drum 380, may be configured to rotate about a second axis, such as an altitude axis.

As illustrated in FIG. 3, drum 380 and base platform 320 may be configured to allow for rotation of the drum 380 about an axis of the drum (representatively shown in FIG. 3 as arrow 380a). Tether gimbal assembly 330 may be coupled to drum 380 and configured to be rotatable about two or more axes. For example, tether gimbal assembly 330 may be configured to rotate about an altitude axis and an azimuth axis. In a further aspect, tether gimbal assembly may be configured to rotate about a single axis, for example, an altitude axis. In an example embodiment, base platform 320 may be configured to rotate about an azimuth axis such that it may be sufficient for tether gimbal assembly 330 to rotate about a single axis (e.g., an altitude axis).

Flexible coupling 340 may include a first end 340A and a second end 340B. First end 340A of flexible coupling 340 may be coupled to tether gimbal assembly 330. In an example embodiment, second end 340B may be coupled to slip ring 350 and may be placed along a central axis of drum 380 (representatively shown in FIG. 3 as arrow 380A). Cable management apparatus 300 may further include second flexible coupling 342. Second flexible coupling 342 may be used to route cables, tether 370, or other components through base platform 320, support tower 310, or other components to the ground. Other configurations of flexible couplings may be used as well. For example, slip ring 350 may be coupled to tether gimbal assembly 330. Consequentially, only one flexible coupling may be used to route cables, tether 370, or other components of cable management apparatus from slip ring 350 to the ground.

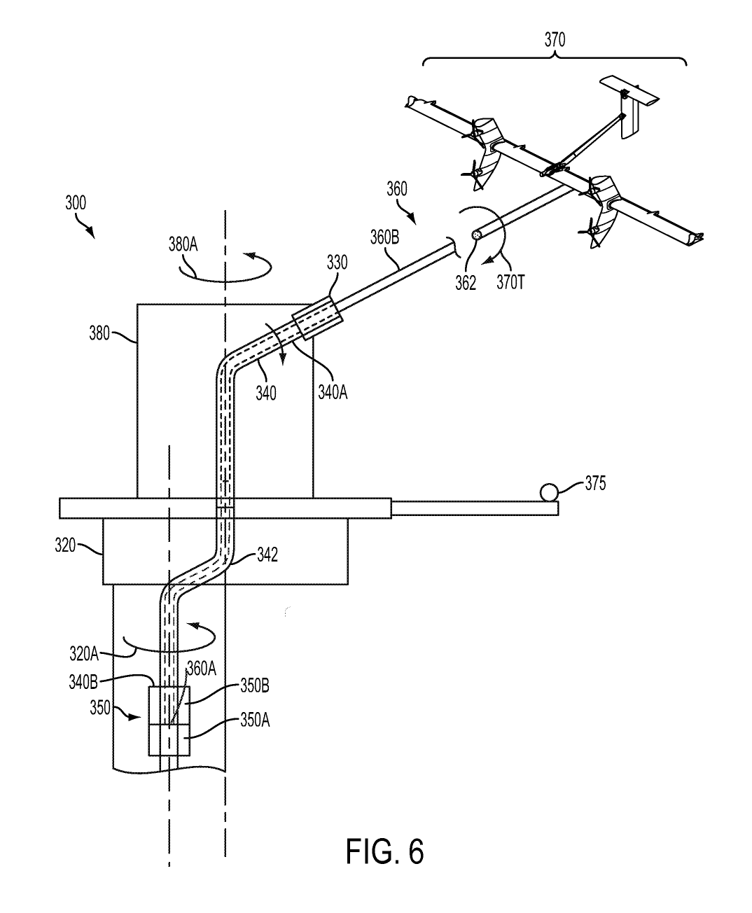

In a further aspect (and as described below in reference to FIG. 6), slip ring 350 may be in a different location. For example, slip ring 350 may be near the ground in support tower 310. Consequentially, only one flexible coupling may be used to route cables, tether 370, or other components of cable management apparatus from tether gimbal assembly 330 to the slip ring 350.

In a further aspect, more than two flexible couplings may be used. For example, a first flexible coupling may be coupled to tether gimbal assembly 330 and extend towards the bottom of drum 380. A second flexible coupling may be coupled to the first flexible coupling at the bottom of drum 380 and extend to the bottom of base platform 320. A third flexible coupling may be coupled to the second flexible coupling at the bottom of base platform 320 and extend towards the bottom of support tower 310. In this example, slip ring 350 may be coupled between any of the flexible couplings or at any point along the flexible couplings.

Slip ring 350 may include a stationary slip ring portion 350A, a rotatable slip ring portion 350B, and two or more insulated electrically conductive pathways (not shown). Stationary slip ring portion 350A may be configured to remain substantially stationary relative to rotation of drum 380 about the axis of drum 380. For example, stationary slip ring portion 350A may be fixed to base platform 320.

The use of the word stationary in stationary slip ring portion 350A is not intended to limit stationary slip ring portion 350A to a stationary configuration. Rather, stationary slip ring portion 350A may be stationary with respect to the ground or with respect to a component of cable management apparatus 300, such as support tower 310, base platform 320, tether gimbal assembly 330, or drum 380 but rotating with respect to the ground or other components of cable management apparatus 300. For example, stationary slip ring portion 350A may be stationary with respect to support tower 310 and include bearings to allow for rotation with respect to the ground.

In another example, stationary slip ring portion 350A may be stationary with respect to drum 380 (but rotating with respect to other components of cable management apparatus 300). In this example, rotatable slip ring portion 350B may be coupled to tether gimbal assembly 330 and configured to substantially rotate with the rotation of tether 360. Other configurations of rotation of portions of slip ring 350 may be used as well.

Stationary slip ring portion 350A may include two or more insulated electrical conductors which may feed into, or received power or signals from, one or more ground-side connections (not shown). Rotatable slip ring portion 350B may be configured to rotate relative to stationary slip ring portion 350A and may include two or more insulated electrical conductors. Additionally, rotatable slip ring portion 350B may be coupled to second end 340B of flexible coupling 340. Slip ring 350 may further include two or more insulated electrically conductive pathways between the two or more insulated electrical conductors of stationary slip ring portion 350A and the two or more electrical conductors of rotatable slip ring portion 350B. Preferably, each insulated electrical conduct in rotatable slip ring portion 350B electrically and rotatably connects to a corresponding insulated electrical conduct in stationary slip ring portion 350A.

Tether 360 may include two or more insulated electrical conductors 362, a proximate tether end 360A, a main tether body 360B, and a distal tether end 360C. Main tether body 360B may extend through tether gimbal assembly 330 and may extend through flexible coupling 340. Proximate tether end 360A may be configured such that the two or more electrical conductors 362 are coupled to the two or more insulated electrical conductors of rotatable slip ring portion 350B. Preferably, each insulated electrical conductor 362 electrically connects to a corresponding insulated electrical conduct in rotatable slip ring portion 350B. Distal tether end 360A may extend outside of drum 380 and be configured to electrically couple two or more electrical conductors 362 of tether 360 to an aerial vehicle 370.

In operation, aerial vehicle 370 may fly in a circular path, such as path 372, to convert kinetic wind energy to electrical energy. Tether 360, as a result of being coupled to aerial vehicle 370 that may be flying in continuous circles, may continuously rotate in one direction during the flight of aerial vehicle 370. As illustrated in FIG. 3, tether 360 may rotate about a central tether axis (representatively shown in FIG. 3 as arrow 370T). Consequentially, it may be desirable to have a cable management system that allows for tether rotation and helps reduce strain on the tether. For example, it may be desirable to avoid twisting a conductive tether because, among other reasons, the conductive tether may be damaged if it is overly twisted.

In an example embodiment, base platform 320 may be rotatable about a base axis (representatively shown in FIG. 3 as arrow 320a) and coupled to drum 380, which in turn, is rotatable about a drum axis (representatively shown in FIG. 3 as arrow 380a). As illustrated in FIG. 3, drum 380 may be a vertical drum that is rotatable about the illustrated drum axis. In a further aspect, the base axis and the drum axis may be coaxial. Alternatively, and not shown, drum 380 may be a horizontal drum that is rotatable about a central axis (e.g., an axis turned 90 degrees from the illustrated drum axis). In a further aspect, the base axis and the drum axis may have different orientations, or, in other words, may not be parallel.

Tether 360 may need to carry supplied electrical power, generated electrical power, control signals, and/or other sensory information between aerial vehicle 370 of an AWT and various ground side components of cable management apparatus 300. Tether 360 may further need to assist with fixturing aerial vehicle 370 of the AWT to a ground side component. For example, tether 360 may be used to assist with retrieval of aerial vehicle 370 and to perch aerial vehicle 370 on a ground side component such as perch platform 375. Thus, beneficial means are provided to convey electrical signals to or from a rotating tether to ground side components and to increase the lifespan of the tether (as compared to a cable management apparatus that does not account for tether rotation).

For example, as described previously in reference to FIG. 3, tether 360, stationary slip ring portion 350A, and rotatable slip ring portion 350B may each include two or more insulated electrical conductors. Rotating tether 360 and slip ring 350 may operate together to convey electrical signals from aerial vehicle 370 of an AWT to ground side components of cable management apparatus 300. Likewise, rotating tether 360 and slip ring 350 may operate together to convey electrical signals from ground side components of cable management apparatus 300 to aerial vehicle 370. In a further aspect, tether 360, stationary slip ring portion 350A, and rotatable slip ring portion 350B may each include one or more insulated electrical conductors.

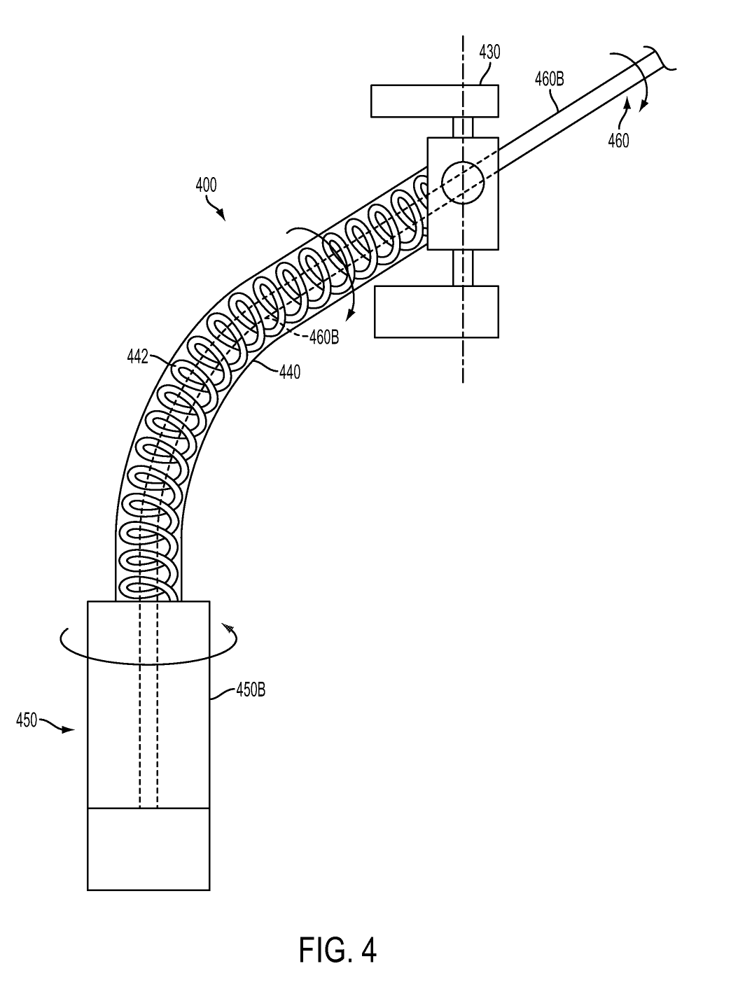

To provide a safe path for tether 360 to reach slip ring 350, flexible coupling 340 may be used to couple tether gimbal assembly 330 to slip ring 350. Flexible coupling 340 may come in various forms. For example, flexible coupling 340 may include a torsion spring which constrains tether 360. The torsion spring may be used to accumulate potential energy generated from the rotation of tether 360. When the torsion spring has turned enough such that the accumulated potential energy in the torsion spring is greater than the apparent overturning moment of inertia of the rotatable slip ring portion 350B, the torsion spring will turn the rotatable slip ring portion 350B and help alleviate twists that have accumulated in tether 360. Further description of an example embodiment with a torsion spring is provided below in reference to FIG. 4.

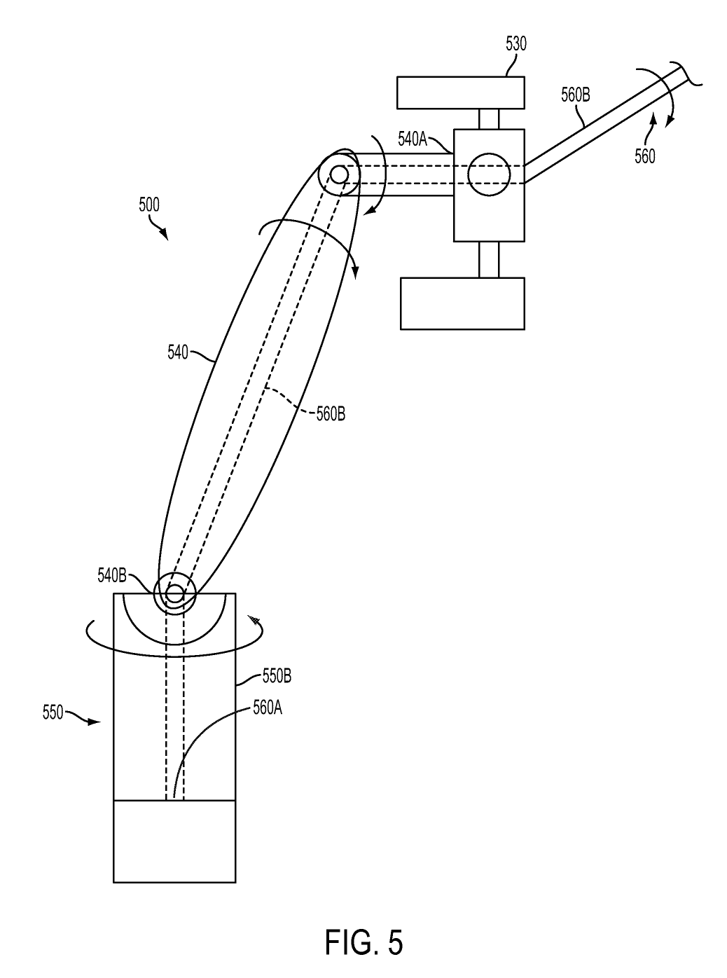

In a further aspect, flexible coupling 340 may be a universal joint through which tether 360 passes. A universal joint may be any joint or coupling system that can be used to transmit rotary motion of tether 360 through multiple axes to slip ring 350. Further description of an alternative embodiment with a universal joint is provided below in reference to FIG. 5. Other types of flexible coupling may also be used.

Slip ring 350 may be a standard industrial slip ring, that is, an electromechanical device that allows for the transmission of power and electrical signals from a rotating structure to a stationary structure. As described above in reference to FIG. 3, slip ring 350 allows for transmission of power and/or electrical signals from rotating tether 360 to stationary support tower 310 through rotatable base platform 320.

FIG. 4 illustrates portions of a cable management apparatus including a torsion spring flexible coupling, according to an example embodiment. Cable management apparatus 400 and its components may be the same or similar to, and operate in the same manner, or in a similar manner to, cable management apparatus 300. For example, tether gimbal assembly 430 may be the same or similar to tether gimbal assembly 330, slip ring 450 may be the same or similar to slip ring 350, tether 660 may be the same or similar to tether 360, and so on.

As illustrated in FIG. 4, flexible coupling 440 may include torsion spring 442. Torsion spring 442 may constrain part of main tether body 460B inside torsion spring 442. Torsion spring 442 may be configured to accumulate potential energy generated from rotation of tether 460. When torsion spring 442 has accumulated enough potential energy (e.g., torsion spring 442 has turned by some amount) such that the accumulated potential energy in torsion spring 442 is greater than the apparent overturning moment of inertia of the rotatable slip ring portion 450, torsion spring 442 will turn rotatable slip ring portion 450B and help alleviate twists that have accumulated in tether 460.

FIG. 5 illustrates portions of a cable management apparatus including a universal joint flexible coupling, according to an example embodiment. Cable management apparatus 500 and its components may be the same or similar to, and operate in the same manner, or in a similar manner to, cable management apparatus 300. For example, tether gimbal assembly 530 may be the same or similar to tether gimbal assembly 330, slip ring 550 may be the same or similar to slip ring 350, and so on.

As illustrated in FIG. 5, flexible coupling may be a universal joint 540. Universal joint 540 may include a first end 540A and a second end 540B. The first end 540A may be coupled to tether gimbal assembly 530. The second end 540B may be coupled to a rotatable portion 550B of slip ring 550. Universal joint 540 may constrain main tether body 560b inside universal joint 540. A universal joint may be any joint or coupling system that can be used to transmit rotary motion of tether 560 through multiple axes to slip ring 550. As tether 560 rotates, universal joint 540 may be configured to rotate with tether 560. As universal joint 540 rotates, rotatable slip ring portion 550B may rotate as a result of second end 540B being coupled to rotatable slip ring portion 550B. The rotation of rotatable slip ring portion 550B may help reduce the possible accumulation of twists in tether 560, or alleviate twists that have accumulated in tether 560.

FIG. 6 is a cross-sectional view of a cable management apparatus, according to an example embodiment. Cable management apparatus 600 and its components may be the same or similar to, and operate in the same or in a similar manner to, cable management apparatus 300, 400, and/or 500.

FIG. 6 illustrates an example embodiment where slip ring 650 is located in support tower 610. In this example embodiment, slip ring 650 may be coupled to support tower 610. Stationary slip ring portion 650A may be configured to be substantially stationary with respect to support tower 610. For example, as support tower 610 rotates about its central axis (shown representatively in FIG. 6 as arrow 620a), stationary slip ring portion 650A may substantially rotate with support tower 610. Rotatable slip ring portion 650B may be configured to rotate in a direction of rotation in relation to tether 670 (direction of rotation representatively shown in FIG. 6 as arrow 670T).

Flexible coupling 640 may include a first end 640A and a second end 640B. Second end 640B may be coupled to rotatable slip ring portion 650B and first end 640A may be coupled to tether gimbal assembly 630. As described above, other configurations of flexible coupling 640 may be used. For example, the cable management apparatus may include multiple flexible couplings. Alternatively, the slip ring may be placed at any point from tether gimbal assembly 630 to the ground.

### CONCLUSION

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A cable management apparatus, comprising:
a drum that is rotatable about an axis of the drum, wherein the drum includes an exterior surface and an interior cavity;
a tether gimbal assembly attached to the drum and rotatable about at least one axis;
a flexible coupling comprising:
a first end coupled to the tether gimbal assembly; and
a second end;
a slip ring, comprising:
a stationary slip ring portion configured to remain substantially stationary relative to rotation of the drum about the axis of the drum, wherein the stationary slip ring portion includes at least one insulated electrical conductor;
a rotatable slip ring portion configured to rotate relative to the stationary slip ring portion, wherein the rotatable slip ring portion includes at least one insulated electrical conductor, and wherein the rotatable slip ring portion is coupled to the second end of the flexible coupling; and
at least one insulated electrically conductive pathway between the at least one insulated electrical conductor of the stationary slip ring portion and at least one insulated electrical conductor of the rotatable slip ring portion.
a tether, comprising:
at least one insulated electrical conductor;
a distal tether end outside of the drum, configured to electrically couple the at least one insulated electrical conductor of the tether to an external electrical device;
a main tether body extending through the tether gimbal assembly and through the flexible coupling; and
a proximate tether end, wherein the at least one insulated electrical conductor of the tether is coupled to the at least one insulated electrical conductor of the rotatable slip ring portion.

2. The apparatus of claim 1, wherein the external electrical device is an aerial vehicle.

3. The apparatus of claim 1, wherein the tether gimbal assembly is located at least partially in the interior cavity of the drum.

4. The apparatus of claim 1, wherein the slip ring is located in the interior cavity of the drum.

5. The apparatus of claim 1, wherein the tether gimbal assembly is further rotatable about a second axis that is substantially perpendicular to the first axis.

6. The apparatus of claim 1, wherein the flexible coupling comprises a universal joint through which the tether passes.

7. The apparatus of claim 1, wherein the flexible coupling comprises a torsion spring that is configured to store as potential energy an energy generated from rotation of the tether, and wherein the torsion spring is configured to rotate the rotatable slip ring portion when the stored potential energy is greater than the overturning inertia moment of the rotatable slip ring portion.

8. The apparatus of claim 1, wherein the axis of the drum is a vertical axis.

9. The apparatus of claim 1, wherein the axis of the drum is a horizontal axis.

10. The apparatus of claim 1, wherein the slip ring is disposed coaxially to the axis of the drum.

11. The apparatus of claim 1, further comprising a second flexible coupling, wherein the second flexible coupling comprises a first end coupled to the stationary slip ring portion.

12. A cable management apparatus, comprising:
a drum that is rotatable about an axis of the drum, wherein the drum includes an exterior surface and an interior cavity;
a support tower;
a base platform coupled to the drum and rotatably coupled to the support tower;
a tether gimbal assembly attached to the drum and rotatable about at least one axis;
a flexible coupling comprising:
a first end coupled to the tether gimbal assembly; and
a second end;
a slip ring, comprising:
a stationary slip ring portion configured to remain substantially stationary relative to rotation of the support tower about the axis of the support tower, wherein the stationary slip ring portion includes at least one insulated electrical conductor;
a rotatable slip ring portion configured to rotate relative to the stationary slip ring portion, wherein the rotatable slip ring portion includes at least one insulated electrical conductor, and wherein the rotatable slip ring portion is coupled to the second end of the flexible coupling; and
at least one insulated electrically conductive pathway between the at least one insulated electrical conductor of the stationary slip ring portion and at least one insulated electrical conductor of the rotatable slip ring portion.
a tether, comprising:
at least one insulated electrical conductor coupled to the tether;
a distal tether end outside of the drum, configured to electrically couple the at least one insulated electrical conductor of the tether to an external electrical device;
a main tether body extending through the tether gimbal assembly and through the flexible coupling; and
a proximate tether end, wherein the at least one insulated electrical conductor of the tether is coupled to the at least one insulated electrical conductor of the rotatable slip ring portion.

13. The apparatus of claim 12, wherein the stationary slip ring portion is configured to remain substantially stationary relative to the base platform.

14. The apparatus of claim 12, wherein the slip ring is disposed coaxially to an axis through which the base platform rotates about the support tower.

15. A cable management apparatus, comprising:
a drum that is rotatable about an axis of the drum, wherein the drum includes an exterior surface and an interior cavity;
a support tower;
a base platform coupled to the drum and rotatably coupled to the support tower;
a tether gimbal assembly attached to the drum, wherein the tether gimbal assembly is rotatable about at least two axes: (i) an altitude axis, and (ii) an azimuth axis;
a flexible coupling comprising:
a first end coupled to the tether gimbal assembly; and
a second end;
a slip ring, comprising:
a stationary slip ring portion configured to remain substantially stationary relative to rotation of the drum about the axis of the drum, wherein the stationary slip ring portion includes at least two insulated electrical conductors;
a rotatable slip ring portion configured to rotate relative to the stationary slip ring portion, wherein the rotatable slip ring portion includes at least two insulated electrical conductors, and wherein the rotatable slip ring portion is coupled to the second end of the flexible coupling; and
at least two insulated electrically conductive pathways between the at least two insulated electrical conductors of the stationary slip ring portion and at least two insulated electrical conductors of the rotatable slip ring portion.
a tether, comprising:
at least two insulated electrical conductors coupled to the tether;
a distal tether end outside of the drum, configured to electrically couple the at least two insulated electrical conductors of the tether to an aerial vehicle;
a main tether body extending through the tether gimbal assembly and through the flexible coupling; and
a proximate tether end, wherein the at least two insulated electrical conductors of the tether are coupled to the at least two insulated electrical conductors of the rotatable slip ring portion.

16. The apparatus of claim 15, wherein the axis of the drum is a vertical axis.

17. The apparatus of claim 16, wherein the slip ring is located in the interior cavity of the drum.

18. The apparatus of claim 16, wherein the slip ring is located in the support tower.

19. The apparatus of claim 15, wherein the axis of the drum is a horizontal axis.

20. The apparatus of claim 19, where the slip ring is located in the interior cavity of the drum.
